(19) United States
(12) Patent Application Publication
(10) Pub. No.: US 2008/0040957 A1
(43) Pub. Date: Feb. 21, 2008

(54) Stylized photograph or negative viewer

(76) Inventors: Denine Mary Wish, Ambler, PA (US); Robert Lawrence Barrett, Ambler, PA (US)

Correspondence Address: Gregory M. Murphy, 12760 Second Branch Road, Chesterfield, VA, 23838, US

(21) Appl. No.: 11/506,679

(22) Filed: Aug. 18, 2006

(51) Int. Cl. G02B 27/02

(52) U.S. Cl. 40/363

(57) ABSTRACT

An image viewer in the shape of a physical relief of a pregnant woman is disclosed, the image viewer comprising a housing, the housing shaped as a physical relief of a pregnant woman and comprising a cavity, an aperture to the cavity; and an image holder, positioned to hold an image in line with the aperture. In some embodiments, the housing of the image viewer may be integral to a photograph album such that the housing forms the front cover of the photograph album. In some embodiments, the image viewer may further comprise a lighting system, comprising a light source disposed in the cavity, a light source switch electrically connected to the light source and disposed external of the cavity, and a light source power source electrically connected to the light source and the light source switch. The housing may also comprise clothing and a lens positioned in the aperture.

### BACKGROUND OF THE INVENTION:

This invention is generally directed to an apparatus for viewing a photograph or negative. More particularly, the invention is directed to a viewer in the shape of a woman's pregnant stomach.

During pregnancy, it is common for multiple images (e.g., sonograms or ultrasounds) to be taken of the developing child. These images are routinely provided to expecting parents. Often, multiple copies of such sonograms or ultrasounds are provided, so that the expecting parents may share such images with others.

These images are often stored and displayed in typical photo albums. However, such an arrangement is less than ideal for such pictures. Sonogram and ultrasounds images are often dark, and are more easily viewed when light is either directly provided, or provided to the rear of the image. When placed in a typical photo album, the detail of the image is often difficult to discern.

Accordingly, there is a need for a viewer more suited for viewing sonogram or ultrasound images.

Additionally, sonograms or ultrasounds are generally the first images of a child, and as such are kept as mementos and keepsakes. Display and storage of these images are often limited to typical photo albums, whose drawbacks are discussed above. Such typical photo albums generally do not emphasize the importance and often uniqueness of the sonogram or ultrasound, when compared to other pictures.

Accordingly, there is a need for a display device for sonogram or ultrasound images that may be more suitable for such images and may provide the expecting parents with a keepsake of not only the images, but of the pregnancy in general.

### SUMMARY OF THE INVENTION

Aspects of the invention include an image viewer in the shape of a physical relief of a pregnant woman is disclosed, the image viewer comprising a housing, the housing shaped as a physical relief of a pregnant woman and comprising a cavity, an aperture to the cavity; and an image holder, positioned to hold an image in line with the aperture. In some embodiments, the housing of the image viewer may be integral to a photograph album such that the housing forms the front cover of the photograph album. In some embodiments, the image viewer may further comprise a lighting system, comprising a light source disposed in the cavity, a light source switch electrically connected to the light source and disposed external of the cavity, and a light source power source electrically connected to the light source and the light source switch. The housing may also comprise clothing and a lens positioned in the aperture.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### BRIEF DESCRIPTION OF THE DRAWINGS

In order to assist in the understanding of the invention, reference will now be made to the appended drawings, in which like reference characters refer to like elements. The drawings are exemplary only, and should not be construed as limiting the invention.

FIG. 1 is schematic diagram of an image viewer in accordance with some embodiments of the present invention.

FIG. 2 is an isometric view of an image viewer in accordance with some embodiments of the present invention.

FIG. 3 is a side view of an image view in accordance with some embodiments of the present invention.

### DETAILED DESCRIPTION OF THE INVENTION

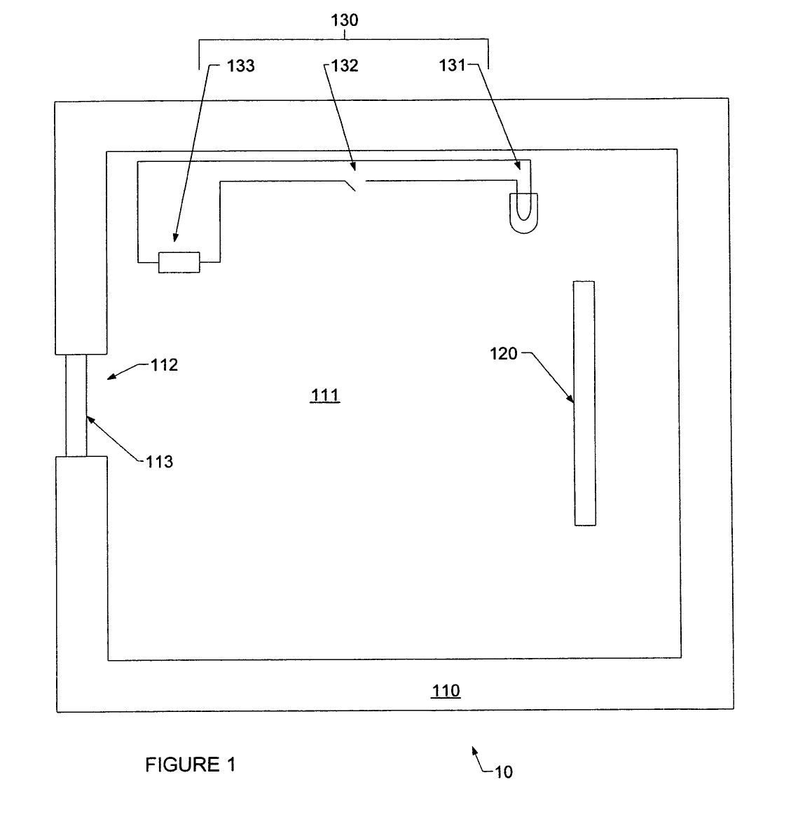

Reference will now be made in detail to embodiments of the invention, examples of which are illustrated in the accompanying drawings. FIG. 1 illustrates a schematic diagram of an image viewer 10 in accordance with some embodiments of the present invention. In general, the viewer 10 is comprised of a housing 110, an image receptacle 120, and a lighting system 130. The housing 110 may have a cavity 111 and may comprise an aperture 112. The aperture 112 may optionally include a magnification or wide-angle (e.g., fish-eye) lens 113.

The image receptacle 120 may be disposed in the cavity 111 of the housing 110, such that when a user looks through the aperture 112, an image mounted on the image receptacle 120 may be seen. The image receptacle 120 may comprise means for holding the image stationary, such as but not limited to mechanical retention (e.g., adhesive, a pouch, a frame, etc.). The image receptacle 120 may be translucent such that light may pass through.

The lighting system 130 may be disposed in the cavity 111 of the housing 110. The lighting system 130 may generally comprise a light source 131, a light source switch 132, and a light source power source 133. The light source 131 may be an incandescent, fluorescent, light emitting diode (LED), or any other type of light emitting source. The light source 131 may be positioned at any location within the cavity 111. It is contemplated that the light source 131 may provide light to the surface of the image exposed to the user (e.g., the front) or may provide light to the opposite surface (e.g., the back). If the light source 131 is positioned to provide light to the back of the image, the image receptacle 120 may be translucent to allow the light to pass through to the image.

Alternatively, the light source 131 may be positioned between the image and the image receptacle 120 or in the image receptacle 120 itself. Such arrangements may provide for the image to be “back lit,” or illuminated from the opposite surface that is displayed to the user.

The light source 131 may be electrically connected to the light source switch 132 which in turn may be electrically connected to the light source power source 133. The light source switch 132 may be any type of electrical switch known in the art. It is contemplated that the light source switch 132 be a manual switch, or be actuated by variations in motion and/or light.

The light source power source 133 may be any power source as known in the art. By way of example only, the power source may be a battery disposed in the viewer, or may be an external power source (e.g., household electrical system) electrically connected to the viewer.

During use, an image may be inserted into the image receptacle 120, such that the image is presented towards the aperture. A user may actuate the light source switch 132 in order to turn on the light source 131. The user may then peer through the aperture 112 to view the image. The user may optionally look through a lens 113 in order to magnify the image, or in order to capture more of the image than the ordinary eye can (e.g., through a wide-angle lens).

When the user is finished, the light source 131 may be manually deactuated via the light source switch 132, or may be deactuated by an optional timer after a specified amount of time has expired.

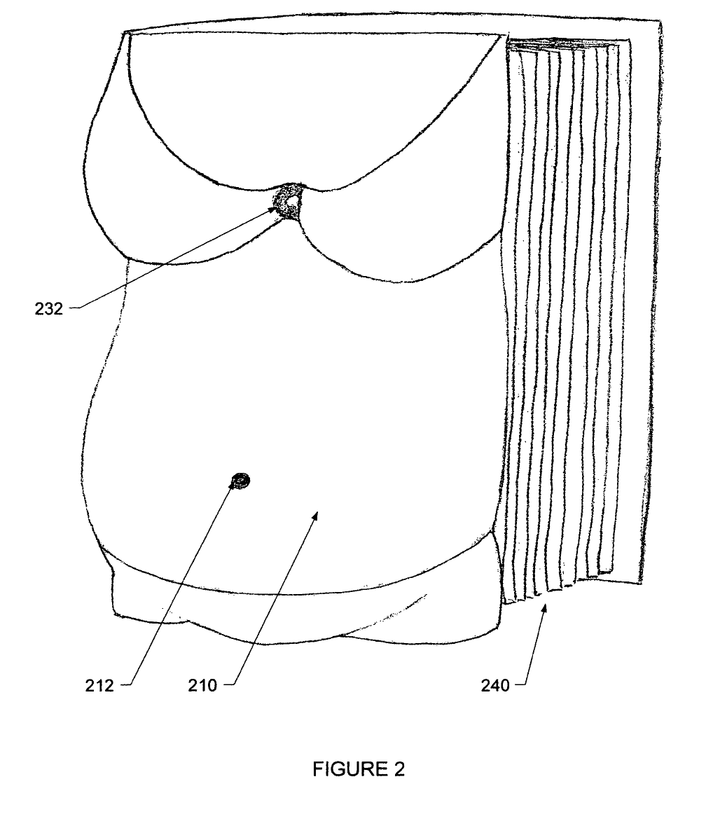

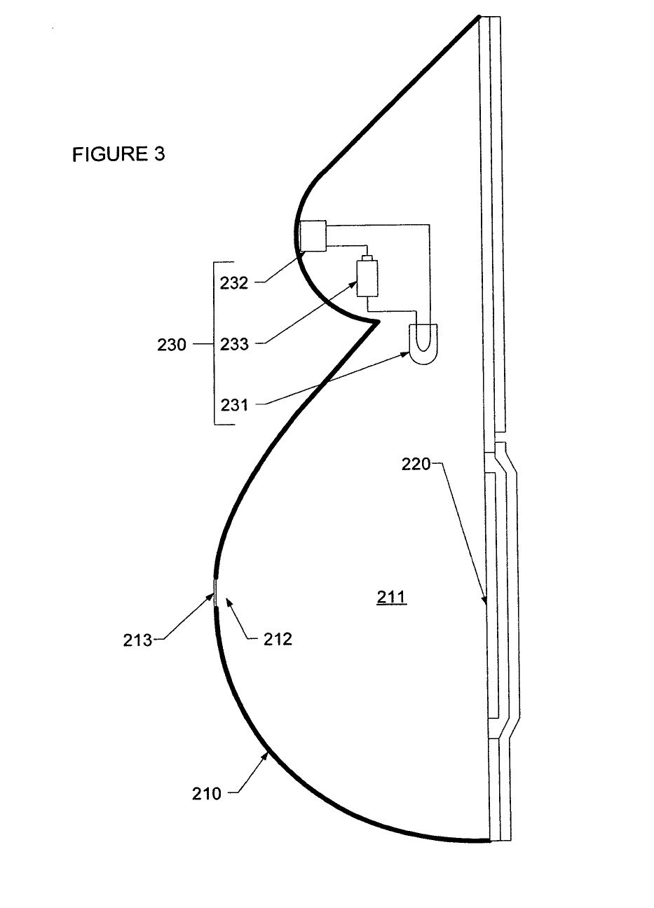

With reference to FIGS. 2 and 3, a stylized viewer 20 in accordance with some embodiments of the present invention will now be discussed. The stylized viewer 20 is generally comprised of a housing 210, an image receptacle 220, and a lighting system 230. The stylized viewer 20 may optionally be formed integral to a photo album 240. As can be seen from FIG. 2, the housing may be in a stylized shape, for example it may be shaped as a physical relief of a pregnant woman. The housing 210 may comprise an internal cavity 211 and an aperture 212 for viewing. With reference to FIGS. 2 and 3, it can be seen that the aperture 212 may be placed on the physical relief at the location of a navel, or “belly button.” The aperture 212 may include a lens 213 which provide magnification or wide-angle viewing (fisheye). The image receptacle 220 may be disposed at the side of the housing 210 opposite of the aperture 212. The image receptacle 220 may comprise any means to hold an image in place, for example by inserting an image between a clear or translucent panel 221 and a backer 222.

The lighting system 230 may again comprise a light source 231, a light source switch 232, and a light source power source 233. With continued reference to FIGS. 2 and 3, the light source 231 may be disposed within the cavity 211. The light source switch 232 may be disposed outside of the cavity 211 so that a user may actuate the light source switch 232 without the need to enter the cavity 211. For example, the light source switch 232 may be used as part of the design of the physical relief, in that the it may be positioned in a suitable location (e.g., at the center connection of an imitation bathing suit top). The light source switch 232 may be manually actuated or may actuated by variations in movement or light. The light source switch 232 may also include a timer, in order to automatically turn off the light source 231 after a specified period of time has elapsed.

The light source power source 233 may comprise an internal or an external power source. If the light source power source 233 comprises an internal power source, it may be a battery located in the cavity 211. If the light source power source 233 comprises an external power source, a connection to an external power source may be provided (e.g., a plug for attaching to standard 110 volt household outlet, a jack for inserting a power cord, etc.).

With continued reference to FIGS. 2 and 3, the general design features of the viewer 20 will now be discussed. The housing 210 may be shaped in as a physical relief of a pregnant woman and may be comprised of any suitable material. For example, the housing may be plastic (e.g., thermoset, thermoplastic, epoxy, etc.), ceramic (e.g., plaster, porcelain, Forton MG, etc.), paper (e.g., paper mache, cardboard, etc.), metal (copper, tin, aluminum, etc.), or any other material. The relief may be presented without clothing, or may be presented with various pieces of clothing (e.g., bathing suit, lingerie, etc.). The optional clothing may be comprised of fabric, or may be any other suitable material (e.g., plastic, paper, etc.).

The viewer 20 may be wall mounted, or a stand-alone display (similar to a “shadow box”). Alternatively, the viewer 20 may be integral to a photo album or scrapbook 240. In this manner, the viewer 20 may provide the photo album or scrapbook 240 with a three-dimensional cover that may more appropriately display a sonogram or ultrasound image.

During use, an image may be inserted into the image receptacle 220, such that the image is presented towards the aperture. A user may actuate the light source switch 232 in order to turn on the light source 231. The user may then peer through the aperture 212 to view the image. The user may optionally look through a lens 213 in order to magnify the image, or in order to capture more of the image than the ordinary eye can (e.g., through a wide-angle lens).

When the user is finished, the light source 231 may be manually deactuated via the light source switch 232, or may be deactuated by an optional timer after a specified amount of time has expired.

The user may also not use the viewer 20, but may instead open the integral photo album or scrapbook 240 to view photographs and memorabilia stored therein.

It will be apparent to those skilled in the art that various modifications and variations can be made in the method, manufacture, configuration, and/or use of the present invention without departing from the scope or spirit of the invention. For example, the image receptacle 220 may hold a liquid crystal display (LCD) image. In this manner, various images may be presented to the viewer as he or she peers through the aperture. In this embodiment, the housing 211 may be removed or opened so that the LCD display may be directly viewed. It is understood that various component may be omitted from the viewer device (e.g., the lighting system, light source, image receptacle) without deviating from the scope or spirit of the invention.

What is claimed is:

1. An image viewer, comprising:
a housing, the housing being shaped as a physical relief of a pregnant woman and comprising a cavity, an aperture to the cavity; and
an image holder, positioned to hold an image in line with the aperture.

2. The image viewer of claim 1, further comprising:
a light source, disposed in the cavity of the housing.

3. The image viewer of claim 2, further comprising a light source switch.

4. The image viewer of claim 3, wherein the light source switch is disposed external of housing.

5. The image viewer of claim 3, wherein the light source switch is actuated by variations in motion or light.

6. The image viewer of claim 3, wherein the light source switch automatically turns the light source off after a specified period of time has elapsed.

7. The image viewer of claim 1, further comprising:
a lens, disposed in the aperture of the cavity, wherein the lens is a magnification lens.

8. The image viewer of claim 1, further comprising:
a lens, disposed in the aperture of the cavity, wherein the lens is a wide-angle lens.

9. The image viewer of claim 1, wherein the housing further comprises clothing.

10. The image viewer of claim 9, wherein the clothing is a bikini bathing suit.

11. The image viewer of claim 1, wherein the image held by the image holder is a sonogram or ultrasound.

12. An image viewer integral to a photograph album, comprising:
a housing, the housing being integral to a cover of the photograph album and shaped as a physical relief of a pregnant woman and comprising a cavity and an aperture to the cavity;
an image holder, disposed within the cavity and positioned to hold an image in line with the aperture, wherein the image is a sonogram or ultrasound;
a lighting system, comprising a light source disposed in the cavity, a light source switch electrically connected to the light source and disposed external of the cavity, and a light source power source electrically connected to the light source and the light source switch.

13. The image viewer of claim 12, wherein the light source switch is actuated by variations in motion or light.

14. The image viewer of claim 12, further comprising:
a lens, disposed in the aperture of the cavity, wherein the lens is a magnification lens.

15. The image viewer of claim 12, further comprising:
a lens, disposed in the aperture of the cavity, wherein the lens is a wide-angle lens.

16. The image viewer of claim 12, wherein the housing further comprises clothing.

17. The image viewer of claim 17, wherein the clothing is a bikini bathing suit.

18. An image viewer, comprising:
a housing, the housing being shaped as a physical relief of a pregnant woman and comprising clothing, a cavity, and an aperture to the cavity wherein the aperture includes a lens;
an image holder, disposed within the cavity and positioned to hold an image in line with the aperture, wherein the image is a sonogram or ultrasound;
a lighting system, comprising a light source disposed in the cavity, a light source switch electrically connected to the light source and disposed external of the cavity, and a light source power source electrically connected to the light source and the light source switch;
and wherein the housing is integral to a photograph album such that the housing forms the front cover of the photograph album.
